(19) United States
(12) Patent Application Publication
(10) Pub. No.: US 2012/0228508 A1
(43) Pub. Date: Sep. 13, 2012

(54) ACTUATING AND DISPLAY PLATE

(75) Inventors: Roland OBERHOLZER, Uster (CH); Florian MEIER, Reichenburg (CH); Raffael ZINGG, Wolfhausen (CH)

(73) Assignee: GEBERIT INTERNATIONAL AG, Jona (CH)

(21) Appl. No.: 13/413,349

(22) Filed: Mar. 6, 2012

(30) Foreign Application Priority Data
Mar. 9, 2011 (EP) 11 157 485.1

(51) Int. Cl. G01J 5/10

(52) U.S. Cl. 250/341.8; 250/338.1

(57) ABSTRACT

An actuating and display plate for a flushing device consists of a non-conductive transparent material, wherein the plate has at least one viewing window, behind which are disposed: an infrared light source, a proximity sensor, which works on a light-reflection basis and is sensitive to the wavelength zone and with which the flushing device can be triggered, and a display light source within the visible light zone. On the plate is provided a back coating, which has a transmission in the range between 2 percent and 15 percent for the visible light zone (22) and a transmission of more than 60 percent for the near-infrared light zone (24).

### TECHNICAL FIELD

The present invention relates to an actuating and display plate for a flushing device, wherein the plate consists of a non-conductive transparent material, wherein the plate has at least one viewing window, and wherein behind the viewing are disposed: at least one infrared light source, at least one proximity sensor, which works on a light-reflection basis and is sensitive to the wavelength zone of the infrared light source and with which the flushing device can be triggered, and at least one display light source within the visible light zone.

### PRIOR ART

From EP 1 961 876, a device for electrically triggering a toilet flushing system is known, wherein the actuating plate is a glass plate or a plate made of a non-conductive material. Behind the plate are sensor keys of capacitively working sensors, which contactlessly detect the approach of the hand of a user. The sensor system of the capacitive sensor keys is stuck on the rear side of the actuating plate.

EP 1 867 613 discloses, from the field of kitchens, a combined actuating and display plate which has, moreover, a rear, opaque coating that leaves a window open. This window is provided with a likewise rear precious metal coating, which in the visible light for the range of wavelengths from 400 nanometres to 750 nanometres is said to have a transmission in the range of 1 to 21% and a scatter of 0 to 1%.

In addition, in this viewing window region behind the glass ceramic plate, a lighting means is provided in order to be able to provide the user with a confirmation of the activation of the capacitive sensor likewise disposed behind the glass ceramic plate.

AT 009 069 U1 discloses an actuating and display plate of a flushing fitting having the features of the preamble of claim 1, which actuating and display plate has a viewing window behind which is provided a proximity sensor, working on a light-reflection basis, with which the fitting can be triggered. The infrared sensor is said, on the one hand, to be capable of detecting the approach of a user to the fitting and, on the other hand, the sensor is capable of discerning when the fitting is due to be triggered. For this, the triggering is achieved via an infrared distance measurement. In addition, behind the viewing window is provided an optical lighting means, with which the operating state or the triggered function is displayed to the user of the fitting. The viewing window is in this case transparent, and symbols and signal fields provided for the display, which if need be are imprinted or stuck on the actuating and display plate, are likewise transparent.

### REPRESENTATION OF THE INVENTION

Starting from this prior art, it is one object of the invention to define a combined actuating and display plate which ensures an improved optical display, whilst safeguarding the functional capability of the contactless triggering.

According to the invention is provided an actuating and display plate for a flushing device, wherein the plate consists of a non-conductive transparent material, wherein the plate has at least one viewing window, and wherein behind the viewing window are disposed: at least one infrared light source, at least one proximity sensor, which works on a light-reflection basis and is sensitive to the wavelength zone of the infrared light source and with which the flushing device can be triggered, and at least one display light source within the visible light zone, wherein a back coating of the plate, which has a transmission in the range between 1 percent and 15 percent for the visible light zone and a transmission of more than 60 percent for the near-infrared light zone, is provided.

The glass plate per se offers the foundation for contactless and hence hygienic triggering and is, in terms of its size, the basis of a wide variety of options for the display and the different triggering operations. By virtue of the fact that in this context a single back coating is provided, a homogeneous display, which safeguards the opaqueness of the sensor system hidden behind the glass plate and, at the same time, ensures the display by virtue of a display lighting means disposed behind the glass plate, can be realized.

A transmission of this coating in the range between 1 percent and 15 percent for the visible light zone allows a clearly visible display for a user even under adverse light conditions, without too high a transmission, as in a fully transparent glass plate without coating, showing details of the sensor system.

In the prior art of AT 009 069 U1, as in other embodiments of sensors in this field, the glass plates provided for this are kept very small in terms of their surface, which spatially precludes, for example, an arrangement of a plurality of sensors for the triggering or display of two different flush water quantities. As a result of the small surface area, the quantity of light which enters through the plate is automatically limited and it is difficult for the user to see through. The prior art according to EP 1 867 613 also then uses an opaque region to limit the incident scattered light.

Here an object of the invention is to define a large-area actuating and display plate which, nevertheless, allows no look-through onto electronics disposed behind it. For this, the coating is chosen in the said transmission range.

For the use of this actuating and display plate having a single coating for contactless detection by an optical contactless distance measurement, it is then a basic feature that the transmission of the coating in the region of the near-infrared wavelength zone is at least 60%, so that the transmittance of the coated plate for infrared light is sufficiently great for infrared distance measurement in both directions. The transmission takes place once for the emitted rays of the infrared light source in one direction, and then for the rays, reflected by the user, in the other direction through the plate.

The transmission behaviour of the actuating plate is crucial for the correct representation of the lighting elements and for the infrared sensor system. On the one hand, a maximum transparency in the IR-zone is realized, on the other hand the transmission in the visible zone must not exceed predetermined values in order to prevent components behind the actuating plate from becoming visible to the user.

Further embodiments are defined in the dependent claims.

### BRIEF DESCRIPTION OF THE DRAWINGS

Preferred embodiments of the invention are described below with reference to the drawings, which serve merely for illustration and should not be interpreted in a restrictive sense. In the drawings:

FIG. 1 shows a transmission spectrum of a coating for use in an illustrative embodiment of the invention, and

FIG. 2 shows a schematic perspective view of an illustrative embodiment of an actuating and display plate according to the invention.

### DESCRIPTION OF PREFERRED EMBODIMENTS

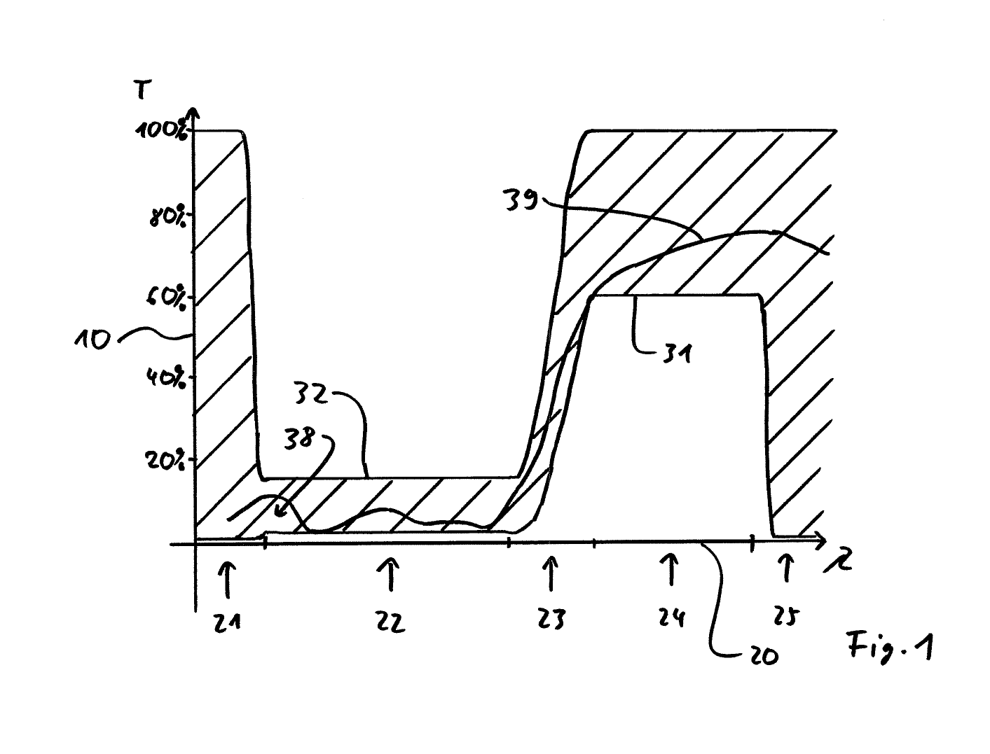

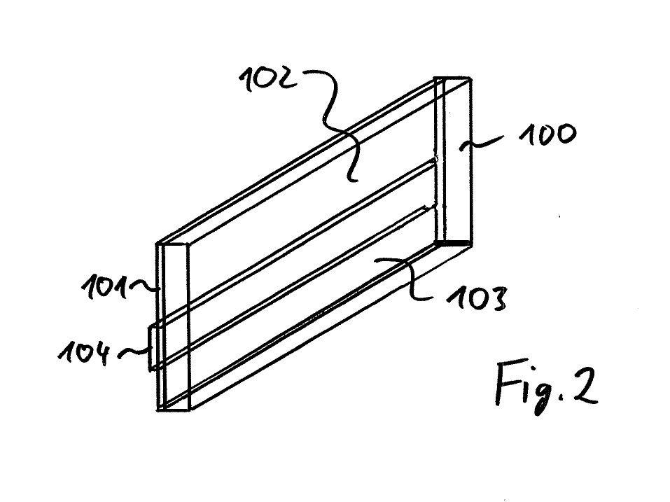

FIG. 1 shows a transmission spectrum of a coating for an actuating and display plate 100 according to the invention, represented in FIG. 2.

The value of the transmission 10 in the thereto possible range between 0 and 100 percent is represented on the axis of ordinate relative to the wavelength 20 for a range from ultraviolet into infrared. The axis of abscissas is divided into five zones 21, 22, 23, 24 and 25.

According to the invention, in respect of the coating, two wavelength zones are essential, in which the transmission behaviour must lie within a specific range. This is the visible light zone 22, this visible light zone being defined between 400 nanometres and 700 nanometres for the human eye. In the case of a restricted colour display, this zone can also be restricted to sub-zones, for example between 400 and 550 nanometres, from 500 to 700 nanometres, in order to utilize more blue or red displays, or having a restricted range from 500 to 600 nanometres.

The second essential wavelength zone is the infrared zone 24 of a wavelength from about 800 nanometres to 2000 nanometres, wherein the normally used infrared light sources deliver a radiation in the range between 850 nanometres and 920 nanometres. Furthermore, in FIG. 1, the ultraviolet zone is provided with the reference numeral 21, whilst the far infrared zone is provided with the reference numeral 25. The transition zone between the visible light zone 22 and the infrared zone 24 is provided with the reference numeral 23. The lower limit of this zone 23 can be altered according to the definition of the upper end of the visible light zone 22. The zone 21 thus relates to the value of the transmission with a wavelength of less than 400 nanometres, or less than 500 nanometres according to the above illustrative embodiments. The far zone 25 thus relates to the value of the transmission with a wavelength of greater than 2000 nanometres, or greater than 920 nanometres according to the above illustrative embodiments. Finally, the transition zone 23 relates to the value of the transmission with a wavelength of greater than 700 nanometres, or greater than 550 or 600 nanometres, and less than 800 nanometres, or less than 850 nanometres according to the above illustrative embodiments. The combinations are fluid and dependent on the chosen coating.

In FIG. 1, with the curve 39, a curve modelled on the real transmission characteristic is plotted, which curve has been employed, in trials, in prototypes of the invention.

According to the invention, a transmission between 1 and 15% for the visible light zone 22 shall be provided in respect of the coating. This transmission is represented by the transmission band limited by the lower limit curve 31 and the upper limit curve 32 and is shaded. In particular, a transmission between 2 and 10% can be provided. Advantageously, transmissions of more than 5% are present only in small part-zones of the critical wavelength zone 22. In the represented illustrative embodiment, a corresponding wavelength part-zone 38 with a higher transmission is found in the wavelength zone close to the ultraviolet. Such a part-zone 38 is a wavelength zone over no more than 150 nanometres in total, advantageously over no more than 100 nanometres in total, in which the transmission curve comprises between 5 and 15 percent. In the trials conducted by the Applicant, coatings were used which produce such zones 38 of up to 70 nanometres in the region of the short-wave visible zone and up to 70 nanometres in the region of the long-wave visible zone, i.e. for example between 400 and 450 nanometres and between 650 and 700 nanometres.

With this transmission in the zone 22, the user of the inventive device is guaranteed to have sufficient perception of the light source, as a display means, disposed behind the actuating plate; conversely, the transmission, in turn, is not so high that the user can recognize, apart from the lighting means, other elements in the installation frame of the display and actuating plate. Preferably, the background of the installation frame is designed or coloured in particular as grey or black, at least not white. If there is no installation frame forming the background, but this is a wall part of a building, then this shall preferably be kept dark.

In the two boundary zones 21 and 25 of the ultraviolet and infrared, it is indicated with the shading between 0 percent and 100 percent that the transmission behaviour of the coating in these zones can be freely chosen; in particular, it can resemble the transmission behaviour of the adjoining zones.

In the transition zone 23 between the visible light zone 22 and the infrared zone 24, a steady transition of the transmission behaviour is advantageously provided, although, here too, this transmission can in principle be freely chosen; in particular, it can be zero; this zone can also be relatively small and comprise just a few nanometres. A steep transition flank of this kind is preferred. In another, non-represented illustrative embodiment having a different coating, the zone 23 extends between 700 and 850 nanometres and steadily rises therein from about 10% transmission to 65% transmission. A zone 38 of enhanced transmission then exists at the upper wavelength zone end 22.

The transmission behaviour in the infrared zone 24 is characterized by its lower limit of 60%. It is essential for a correct detection of the actuation that the infrared light emitted by the sensor light source and reflected back by the user is transmitted to the extent of no less than 60% in order to obtain an adequate response. The transmission in this zone 23 is upwardly open and can amount to up to 100% of the light entering the coating.

FIG. 2 shows in very schematic representation an actuating plate 100, behind which a coating is here represented as a separate surface 101, the thickness of the coating being negligible in relation to the thickness of the supporting actuating plate 100. The coating 101 can comprise, in particular, a display window 102 and a sensor window 103, which windows can be separated by a masking 104. The masking signifies a light-impermeable coating, which in particular lets through neither visible light nor IR light.

Such a coating 104 further has the advantage that it is available as a very strongly adherent coating, which can simultaneously offer a base surface for fastening the actuating plate onto a mounting frame. For this, boundary regions, disposed on the margin of the plate, can be provided. In contrast to the representation of FIG. 2, the opaque coating is not then disposed on a continuous coating 101 but directly on the glass plate 100. Naturally it is possible to provide different arrangements of display windows 102 and sensor windows 103 as long as a light source in the visible light zone is provided as the display lighting, as well as a pair, comprising a sensor light source and sensor detector, which is designed to emit and detect infrared light.

The advantageously present, closed rear space of the actuating unit having the actuating plate according to the invention can easily be the rear space of a wall in which the display and actuating plate is installed, or a separate installation frame can be provided, the surface colour of which is then preferably dark.

It is further possible for the actuating and display plate to have a coating which has a mirroring effect for the viewer. This can be constituted by the said coating having the transmission behaviour of FIG. 1. In other words, the feature that the further or the same coating shows a reflection shall be realized, of course, only for the wavelength zone 22 which is essential for the viewer; insofar as this reflection occurs only for incident light in part-zones of the wavelength zone 22, a colour effect is obtained. The reflection can lie within the visible zone, in particular in the range from 30 to 50 percent, a reduced overall transmission being obtained if an additional coat is applied to the inventive coating. The values of the coating 101 should then be seen in total.

A combined coating of this kind can be an interference filter coating on Borofloat glass, which, given high reflection, produces a damping of 5% in the visible zone up to 700 nanometres and, from 800 nanometres, allows a transmission of over 60%.

The actuating plate can also be provided with a splinter protection film, which has no effect on the transmission and reflection behaviour.

### REFERENCE SYMBOL LIST

10 transmission
20 wavelength
21 ultraviolet zone
22 visible light zone
23 transition zone
24 near-IR zone
25 far IR-zone
31 lower limit curve
32 upper limit curve
38 zone of enhanced transmission
39 real transmission curve
100 actuating and display plate
101 coating
102 display window region
103 sensor window region
104 opaque coating

1. Actuating and display plate for a flushing device, wherein the plate consists of a non-conductive transparent material, wherein the plate has at least one viewing window, and wherein behind the viewing window are disposed:
at least one infrared light source,
at least one proximity sensor, which works on a light-reflection basis and is sensitive to the wavelength zone of the infrared light source and with which the flushing device can be triggered, and
at least one display light source within the visible light zone,
wherein a back coating of the plate, which has a transmission in the range between 1 percent and 15 percent for the visible light zone and a transmission of more than 60 percent for the near-infrared light zone, is provided.

2. Actuating and display plate according to claim 1, wherein the actuating and display plate is a glass plate.

3. Actuating and display plate according to claim 1, wherein on the plate, alongside the viewing window, at least one region having a rear opaque coating of the plate is provided.

4. Actuating and display plate according to claim 1, wherein the back coating has a transmission in the range between 2 percent and 5 percent for the visible light zone.

5. Actuating and display plate according to claim 4, wherein within that visible light zone wavelength zones over no more than 150 nanometres in total have a transmission of more than 5 up to 15 percent.

6. Actuating and display plate according to claim 5, wherein within that visible light zone wavelength zones over no more than 100 nanometres in total have a transmission of more than 5 up to 15 percent.

7. Actuating and display plate according to claim 1, wherein the back coating for the near-infrared light zone has a transmission of more than 70 percent.

8. Actuating and display plate according to claim 1, wherein the actuating and display plate has a coating which has a mirroring effect for the viewer.
